(19) United States
(12) Patent Application Publication
(10) Pub. No.: US 2006/0011433 A1
(43) Pub. Date: Jan. 19, 2006

(54) Damper valve body loading

(76) Inventors: Robert P. Carlstedt, Rochester Hills, MI (US); James J. Siesel, Canton, MI (US); Christopher T. Sledz, Armada, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/894,443

(22) Filed: Jul. 19, 2004

(51) Int. Cl. F16F 9/34

(52) U.S. Cl. 188/322.22; 188/322.15

(57) ABSTRACT

A piston valve assembly for a damper comprises a piston having a central hole and a fluid passageway spaced from the hole. A deflection disc having a central aperture is aligned with the hole. The deflection disc is arranged adjacent to the piston and at least partially blocks the fluid passageway for regulating the flow of hydraulic fluid between the fluid chambers when installed in the damper. A hub, common across different dampers, includes a neck that is arranged in the hole and the aperture of the deflection disc. A retainer abuts an unthreaded outer surface of the hub. During assembly, the retainer is received on the cylindrical outer surface in a slip fit relation. The deflection disc and pistons are loaded to a predetermined clamp load. The retainer is secured to the outer surface by a securing material such as a weld bead.

### BACKGROUND OF THE INVENTION

This invention relates to dampers such as vehicle suspension shock absorbers, struts and the like. More particularly, the invention relates to a common hub design for piston and base valve arrangements enabling a more modular damper.

Dampers such as shock absorbers and struts are used in vehicles to absorb inputs from the roadway to provide a desirable vehicle ride. Typically, vehicle dampers employ a piston that moves through a cylinder having hydraulic fluid. The fluid flows through fluid passageways and valves in the piston, which absorbs the roadway inputs in the form of heat. One common type of piston valve assembly uses deflection discs on either side of the piston. The deflection discs at least partially block the fluid passages in the piston to regulate the fluid flow rate through the passages during the compression and rebound strokes of the damper.

The piston and deflection discs are secured in abutment with one another by the piston rod and nut. The rod includes a shoulder with a neck extending from the shoulder to support the piston and deflection discs. An end of the neck is threaded to receive the nut. The nut is tightened onto the rod to a predetermined torque so that the deflection discs are held securely against the piston. The damping characteristics of the damper are adversely affected if the deflection discs are not properly loaded against the piston. The load on the deflection discs may decrease even after the predetermined torque has successfully been achieved and the damper has passed the final test. Base valves in dampers may experience the same problem. Therefore what is needed is a damper design that provides more consistent loading of the damper valve bodies.

### SUMMARY OF THE INVENTION AND ADVANTAGES

One example of the present invention provides a piston valve assembly for a damper comprising a piston having a central hole and a fluid passageway spaced from the hole. A deflection disc having a central aperture is aligned with the hole. The deflection disc is arranged adjacent to the piston and at least partially blocks the fluid passageway for regulating the flow of hydraulic fluid between the fluid chambers when installed in the damper. A hub arranged between the rod and piston includes a neck that is arranged in the hole and the aperture of the deflection disc. However, the inventive clamping arrangement may also use a rod directly supporting the piston. A retainer abuts an unthreaded outer surface of the hub. Said another way, a line parallel to a hub axis extends along the outer surface and lies in a plane tangential to the outer surface. In one example embodiment, the outer surface is cylindrical in shape having a smooth surface. During assembly, the retainer is received on the cylindrical outer surface in a slip fit relation. The retainer is secured to the outer surface by a securing material such as a weld bead. The same configuration maybe used for a base valve.

The inventive piston valve assembly is manufactured using an inventive method of manufacturing. In one example, the method of manufacturing comprises the steps of providing a hub and installing a deflection disc and piston on the hub. Of course, multiple deflection discs using various configurations may be arranged on either side of the piston. Furthermore, valve components other than deflection discs, such as wire spring biased valves, may be used. The deflection disc and pistons are loaded to a predetermined clamp load. A retainer is placed on the hub in a slip fit relationship thereto and secured to the hub while the deflection disc and pistons are maintained under the predetermined clamp load. The retainer is secured to the hub, for example, by welding.

Accordingly, the above mentioned provides a damper design that provides consistent loading of the damper valve bodies.

### BRIEF DESCRIPTION OF THE DRAWINGS

Other advantages of the present invention can be understood by reference to the following detailed description when considered in connection with the accompanying drawings wherein:

FIG. 1 is a side elevational view of a fully assembled damper manufactured according an inventive manufacturing process for the inventive piston valve assembly;

FIG. 2 is a cross-sectional view of an inventive piston valve assembly including a common inventive hub;

FIG. 3 is a cross-sectional view of the inventive piston valve assembly having a floating compression deflection disc and a fixed rebound deflection disc;

FIG. 4 is a cross-sectional view of the inventive piston valve assembly having fixed compression and rebound deflection discs with a fixed stop on the compression side and a spring loaded biasing member on the rebound side;

FIG. 5 is a cross-sectional view of a base valve for a twin tube shock absorber using the inventive clamping arrangement;

FIG. 6 is a cross-sectional view of a base valve using the inventive clamping arrangement.

### DETAILED DESCRIPTION OF THE PREFERRED EMBODIMENT

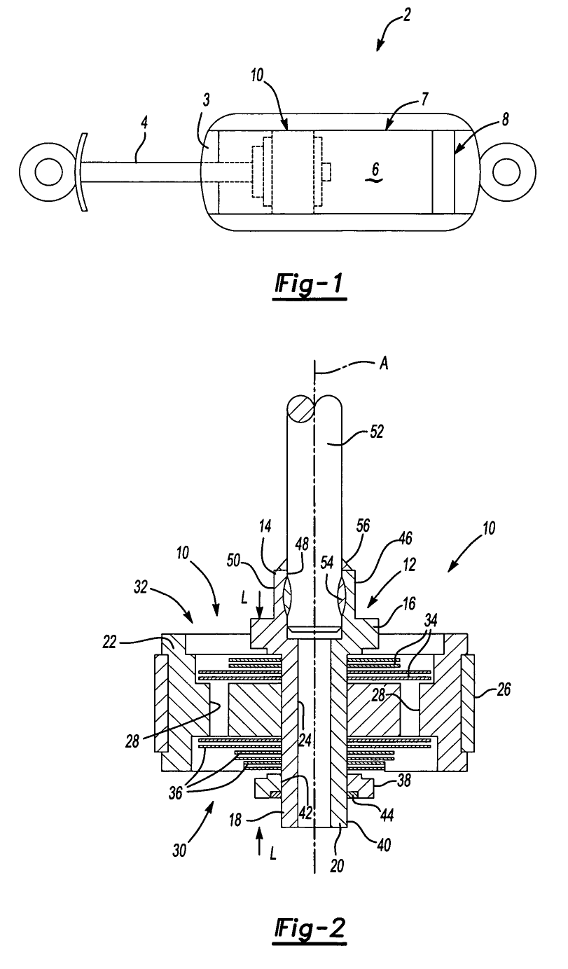

A twin tube shock absorber 2 is shown in FIG. 1. The shock absorber 2 schematically depicts a cylinder head 3 at one end slidingly receiving a rod 4, as is well known in the art. An end of the rod 4 is secured to the inventive piston valve assembly 10, which is arranged in a fluid chamber 6. During a compression stroke, the piston valve assembly 10 moves towards a base valve 8, which regulates the flow of fluid from the fluid chamber 6 to an outer chamber 7. As will be appreciated from the description below, the piston assembly 10 and base valve 8 incorporate an inventive hub 12, which is shown in FIGS. 2-6.

A piston valve assembly 10 of the present invention is shown in FIG. 2. The assembly 10 may be used in a monotube or a twin tube shock absorber. The assembly 10 includes a hub 12 that is designed to be used with different sized pistons and deflection discs to facilitate a more modular damper assembly. However, it should be understood that the inventive clamping arrangement may also be used directly with a rod. The hub 12 includes a first end 14 that is adapted to receive a piston rod. The first end 14 includes a shoulder 16 and a neck 18 extending from the shoulder 16 to a second end 20.

A piston 22 having a hole 24 is installed onto a longitudinal member such as the hub 12, in the example showing or the rod 4, with the neck 18 received in the hole 24. The neck 18 has a generally uniform cylindrical circumference along its length. The piston 22 includes an outer circumference 26 that engages the inner wall of the damper cylinder, as is well known in the art, when the damper is assembled.

The piston 22 includes one or more fluid passages 28 extending between compression 30 and rebound 32 sides of the piston 22. One or more compression deflection discs 34 are arranged on the rebound side 32 of the piston, and one or more rebound deflection disc 36 are arranged on the compression side 30 of the piston 22. The discs 34 and 36 include a central aperture that receives the neck 18. The discs 34 and 36 regulate the fluid flow through the fluid passages 28 to provide a desired damping characteristic as the piston valve assembly 10 moves through the fluid chambers and the damper. The discs 34 and 36 deflect upward and away from the sides 32 and 30 as the fluid within the fluid passage 28 exerts pressure on the discs 34 and 36, as is well known in the art. If the discs 34 and 36 are not firmly retained against the piston 22, the discs 34 and 36 will open under lower pressures resulting in undesired damping characteristics.

The neck 18 includes an outer surface 40 at the end 20. The surface 40 is preferably smooth, cylindrical, and unthreaded. The end 20 may have a shape different than the rest of the neck 18, if desired. The surface 40 may also have a non-circular cross-sectional shape. The surface 40 has a line extending along a length parallel to a hub axis A. The line lies in a plane tangential to the outer surface. A retainer 38 includes a portion having a generally cylindrical inner surface 42 that is received in a slip fit relationship on the outer surface 40 of the neck 18. The slip fit relationship enables the retainer 38 to be moved axially along the surface 40 during loading, as described below. To achieve the slip fit relationship, for example, in the case of a cylinder the smallest diameter along the inner surface 42 is greater than the largest diameter along the outer surface 40 so that the retainer 38 can slide along the neck 18. However, this should not be construed to exclude a configuration in which there is a slight interference fit.

The piston 22 and retainer 38 are loaded to a predetermined clamp load L to force the discs 34 and 36 firmly into abutment with the piston 22, shoulder 16 and retainer 38, in the example shown. As one of ordinary skill will appreciate, it is preferred to have a slip fit relationship between the retainer 38 and neck 18 so that the predetermined clamp load L may be more easily determined. A slight interference fit, while permissible is not as preferred, because the predetermined clamp load L is more difficult to determine since some of the applied load is used to overcome the interference fit, which may vary from one assembly to the next. While the assembly 10 is maintained under a predetermined clamp load L, a securing material 44 is used to secure the retainer 38 to the neck 18. The securing material 44 is a material separate from that of hub 12 or retainer 38, such as a weld bead, in the example shown. At this point in the piston valve assembly manufacturing process, a completed sub-assembly is provided.

Different size piston rods may be installed onto the assembly 10. The hub 12 includes a collar 46 extending from the shoulder 16. The collar 46 includes an inside surface 48 and an outside surface 50. A solid rod 52, for example 12 mm in diameter, may be received in the collar 46 in close fitting relationship to the inside surface 48. The rod 52 may be impulse welded to the inside surface 48 forming a weld bead 54. The rod 52 may also be laser welded forming a weld bead 56 about the circumference of the rod 52 where it meets the collar 46 to form a seal past which fluid will not leak. Alternatively, the hub 12 may be eliminated and the rod 52 may be used to directly support the piston 22 and deflection discs 34, 36. For this type of configuration, the rod 52 provides the shoulder and the end having the surface to which the retainer 38 is attached.

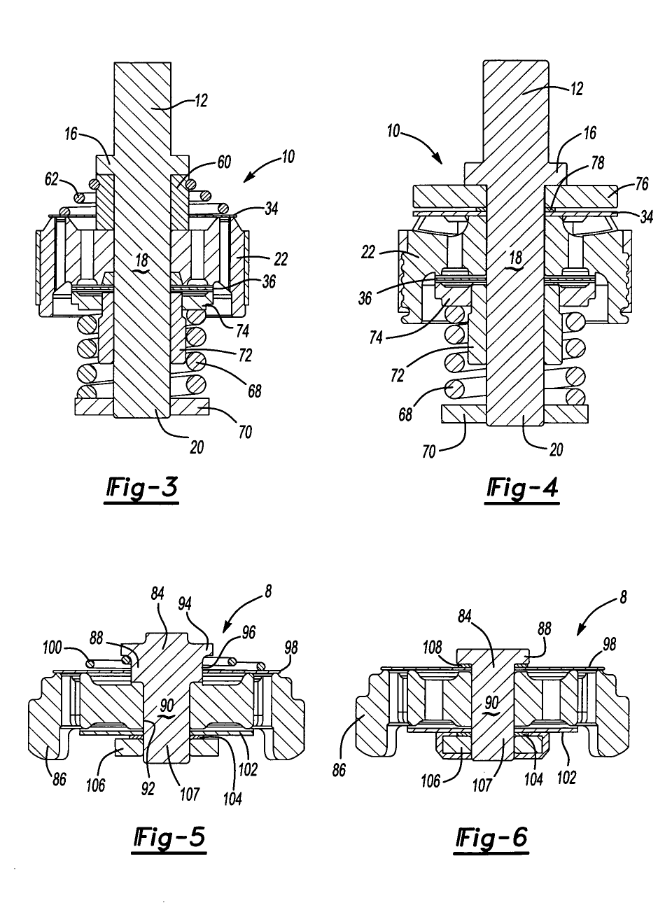

As will be appreciated from the description of FIGS. 3-6, the inventive common hub 12 may be used in any number of configurations of piston valve assemblies 10 or base valves 8. Referring to FIG. 3, a floating-fixed disc arrangement is shown in which the compression side discs 34 are permitted in their entirety to move axially along the axis provided by the hub 12 or float. A spring retainer 60 supporting an end of a spring 62 is received on the neck 18 and is in an abutting engagement with the shoulder 16. The spring 62 biases the compression deflection disc 34 into engagement with the piston 22. The spring retainer 60 also acts as a guide upon which the deflection discs 34 may move axially relative thereto. The rebound side has a fixed disc configuration. Specifically, the rebound discs 36 are captured between a guide 72 such that the deflection discs 36 are axially fixed at the inner periphery. The inventive clamping arrangement is first used for the assembly shown in FIG. 3 to provide a predetermined of the deflection disc 36 by applying the load to the shoulder 16 and guide 72. The guide 72 is secured to the hub 12 in the same manner described relative to the retainer 38 in FIG. 2.

A plate 70 is slidingly received on the guide 70, and the spring 68 is captured between the retainer 70 and plate 74. The inventive clamping arrangement is also used to apply a desired preload to the outer periphery of the discs 36 by compressing the spring 68 to a desired load. The spring 68 is loaded to a desired spring load and the retainer 70 secured to the hub 12, as described above relative to the retainer 38 in FIG. 2. A retainer 70 is secured to an end 20 of the neck 18, in the same manner described above relative to FIG. 2, to capture a spring 68 between the plate 66 and retainer 70. The inventive hub 12 and retainer 70 arrangement provides the unique advantage of enabling a preload to be used to load the spring 68 to a desired spring load prior to securing the retainer 70 to the end 20. Similar to the clamp load applied in FIG. 2, the end of the hub 12 is retained and the retainer 70 is loaded to achieve the desired spring load 68, which enables variation in spring loads due to tolerance stack-ups experienced in manufacturing the piston valve assembly to be eliminated. Once the desired spring load on the spring 68 is achieved, the retainer 70 is welded to the hub 12.

FIG. 4 depicts a piston valve assembly similar to that shown in FIG. 3, except the compression side includes a fixed disc configuration. The hub 12 includes a shoulder having the same diameter as the shoulder 16 shown in FIGS. 2 and 3. However, the piston valve assembly 10 additionally includes a stop 76 arranged between the shoulder 16 and piston 22. A spacer 78 is arranged between the stop 76 and compression discs 34 so that the compression discs 34 pivot about the spacer 78 until they engage the stop 76. The stop 76 need not be affixed or welded to the hub 12 loading the shoulder 16 and guide 72 to a predetermined clamp load applies a desired load to both the discs 34, 36. The guide 72 and retainer 70 are secured in a manner similar to that described relative to FIG. 3.

FIGS. 5 and 6 show the inventive hub 84 for use with base valves 8. Referring to FIG. 5, the hub 84 includes a base valve head 86 received by a neck 90 of the hub 84. The head 86 abuts a hub shoulder 88. A guide 94 extends radially from the hub 84 and is spaced axially from the shoulder 88 away from the head 86. A spring 100 is arranged between the spring retainer 94 and rebound deflection disc 98 biasing the deflection disc 98 with the head 86. On the compression side, a retainer 106 are loaded to a desired clamp load and secured to the hub 84 in the manner described relative to FIG. 2. Compression disc 102 engages the head 86, and a spacer 104 is arranged between the compression deflection disc 102 and the retainer 106.

The base valve 8 shown in FIG. 6 uses a fixed rebound disc arrangement so that the hub 84 does not need the spring retainer shown in FIG. 7. A spacer 108 is arranged between the shoulder 88 and rebound discs 98.

The invention has been described in an illustrative manner, and it is to be understood that the terminology that has been used is intended to be in the nature of words of description rather than of limitation. Obviously, many modifications and variations of the present invention are possible in light of the above teachings. It is, therefore, to be understood that within the scope of the appended claims the invention may be practiced otherwise than as specifically described.

1. A method of manufacturing a damper comprising the steps of:
a) installing a valve and a valve body onto a longitudinal member;
b) sliding a retainer onto the longitudinal member along an axis;
c) loading the valve to a predetermined clamp load; and
d) securing the retainer to the longitudinal member with the valve under the predetermined clamp load to provide a valve assembly.

2. The method according to claim 1, wherein the longitudinal member is a hub, and comprising step e) securing a rod to the hub after performing step d).

3. The method according to claim 1, wherein the valve is a deflection disc.

4. The method according to claim 3, wherein step a) includes capturing a plate between a guide abutting the valve body and deflection disc, the plate movable axially relative to the guide and applying a biasing force to the deflection disc.

5. The method according to claim 4, wherein step c) includes loading a spring arranged between the plate and retainer to the predetermined clamp load corresponding to a predetermined spring load.

6. The method according to claim 4, wherein the deflection disc is axially retained between the valve body and the guide, and the guide is the retainer.

7. The method according to claim 1, wherein the valve body is a head of the valve.

8. The method according to claim 3, wherein step a) includes arranging a spacer between the deflection disc and the retainer to define a gap between the retainer and the deflection disc.

9. The method according to claim 1, wherein step d) includes welding the retainer to the longitudinal member.

10. The method according to claim 9, wherein the welding is laser welding.

11. The method according to claim 1, wherein step d) includes forcing the retainer in an axial direction toward a shoulder on the longitudinal member.

12. A valve assembly for a damper comprising:
a valve body having a central hole and a fluid passageway spaced from said central hole;
a deflection disc having a central aperture aligned with said central hole, said deflection disc adjacent to said valve body and at least partially blocking said fluid passageway;
a longitudinal member having a neck disposed in said central hole and said central aperture; and
a retainer abutting an outer surface of said longitudinal member, said retainer secured to said outer surface by a securing material.

13. The valve assembly according to claim 12, wherein said outer surface is a generally smooth outer cylindrical surface and said retainer includes a generally smooth inner cylindrical surface abutting said outer surface.

14. The valve assembly according to claim 12, wherein said securing material is a weld bead.
